(19) United States
(12) Patent Application Publication
(10) Pub. No.: US 2015/0278585 A1
(43) Pub. Date: Oct. 1, 2015

(54) VIDEO PROCESSING SYSTEM FOR VIDEO SURVEILLANCE AND METHODS FOR USE THEREWITH

(71) Applicant: ViXS Systems, Inc., Toronto (CA)

(72) Inventors: Indra Laksono, Richmond Hill (CA); Sally Jean Daub, Toronto (CA); John Pomeroy, Markham (CA); Xu Gang Zhao, Maple (CA)

(73) Assignee: ViXS Systems, Inc., Toronto (CA)

(21) Appl. No.: 14/677,102

(22) Filed: Apr. 2, 2015

Related U.S. Application Data
(63) Continuation-in-part of application No. 14/590,303, filed on Jan. 6, 2015.
Application No. 14/590,303 is a continuation-in-part of application No. 14/217,867, filed on Mar. 18, 2014.
Application No. 14/217,867 is a continuation-in-part of application No. 14/477,064, filed on Sep. 4, 2014.
Application No. 14/477,064 is a continuation-in-part of application No. 13/467,522, filed on May 9, 2012.
(60) Provisional application No. 61/635,034, filed on Apr. 18, 2012.

(51) Int. Cl. G06K 9/00; H04N 7/18

(52) U.S. Cl. CPC G06K 9/00288; G06K 9/00369; G06K 9/00302; H04N 7/18

(57) ABSTRACT

Aspects of the subject disclosure may include, for example, a system that includes a signal interface configured to receive a plurality of video signals from a corresponding plurality of video cameras. A surveillance processor is configured to process the plurality of video signals and to recognize at least one person in at least one of the plurality of video signals and an emotional state corresponding to the at least one person and that generates surveillance data corresponding to the at least one person, based on the emotional state corresponding to the at least one person. Other embodiments are disclosed.

### CROSS REFERENCE TO RELATED PATENTS

The present application claims priority under 35 U.S.C. 120 as a continuation-in-part of U.S. Utility application Ser. No. 13/467,522, entitled, “VIDEO PROCESSING SYSTEM WITH PATTERN DETECTION AND METHODS FOR USE THEREWITH,” filed on May 9, 2012, which claims priority pursuant to 35 U.S.C. §119(e) to U.S. Provisional Application No. 61/635,034, entitled, “VIDEO PROCESSING SYSTEM WITH PATTERN DETECTION AND METHODS FOR USE THEREWITH,” filed on Apr. 18, 2012, all of which are hereby incorporated herein by reference in their entirety and made part of the present U.S. Utility patent application for all purposes.

The present U.S. Utility patent application also claims priority pursuant to 35 U.S.C. §120 as a continuation-in-part of U.S. Utility application Ser. No. 14/590,303, entitled “AUDIO/VIDEO SYSTEM WITH INTEREST-BASED AD SELECTION AND METHODS FOR USE THEREWITH”, filed Jan. 6, 2015, which is a continuation-in-part of U.S. Utility application Ser. No. 14/217,867, entitled “AUDIO/VIDEO SYSTEM WITH USER ANALYSIS AND METHODS FOR USE THEREWITH”, filed Mar. 18, 2014, and claims priority pursuant to 35 U.S.C. §120 as a continuation-in-part of U.S. Utility application Ser. No. 14/477,064, entitled “VIDEO SYSTEM FOR EMBEDDING EXCITEMENT DATA AND METHODS FOR USE THEREWITH”, filed Sep. 4, 2014, all of which are hereby incorporated herein by reference in their entirety and made part of the present U.S. Utility patent application for all purposes.

### TECHNICAL FIELD OF THE DISCLOSURE

The present disclosure relates to video processing used in video surveillance systems.

### DESCRIPTION OF RELATED ART

Video surveillance systems typically include a plurality of video cameras. Video data can be reviewed by surveillance personnel in real-time. The video data can be encoded and stored for later review.

Video encoding has become an important issue for modern video processing devices. Robust encoding algorithms allow video signals to be transmitted with reduced bandwidth and stored in less memory. Standards have been promulgated for many encoding methods including the H.264 standard that is also referred to as MPEG-4, part 10 or Advanced Video Coding, (AVC). Encoding algorithms have been developed primarily to address particular issues associated with broadcast video and video program distribution.

Further limitations and disadvantages of conventional and traditional approaches will become apparent to one of ordinary skill in the art through comparison of such systems with the present disclosure.

### BRIEF DESCRIPTION OF THE SEVERAL VIEWS OF THE DRAWINGS

FIG. 1 presents a block diagram representation of a video processing system 102 in accordance with an embodiment of the present disclosure.

FIG. 2 presents a block diagram representation of a video processing system 102 in accordance with an embodiment of the present disclosure.

FIG. 3 presents a block diagram representation of a surveillance processor and video codec in accordance with an embodiment of the present disclosure.

FIG. 4 presents a pictorial diagram representation of an image in accordance with a further embodiment of the present disclosure.

FIG. 5 presents a pictorial diagram representation of an image in accordance with a further embodiment of the present disclosure.

FIG. 6 presents a pictorial diagram representation of an image in accordance with a further embodiment of the present disclosure.

FIG. 7 presents a block diagram representation of a surveillance site in accordance with a further embodiment of the present disclosure.

FIG. 8 presents pictorial diagram representation of a screen display in accordance with a further embodiment of the present disclosure.

FIG. 9 presents a block diagram representation of a pattern detection module 175 in accordance with a further embodiment of the present disclosure.

FIG. 10 presents a block diagram representation of a candidate region detection module 320 in accordance with a further embodiment of the present disclosure.

FIG. 11 presents a flowchart representation of a method in accordance with an embodiment of the present disclosure.

### DETAILED DESCRIPTION OF THE DISCLOSURE INCLUDING THE PRESENTLY PREFERRED EMBODIMENTS

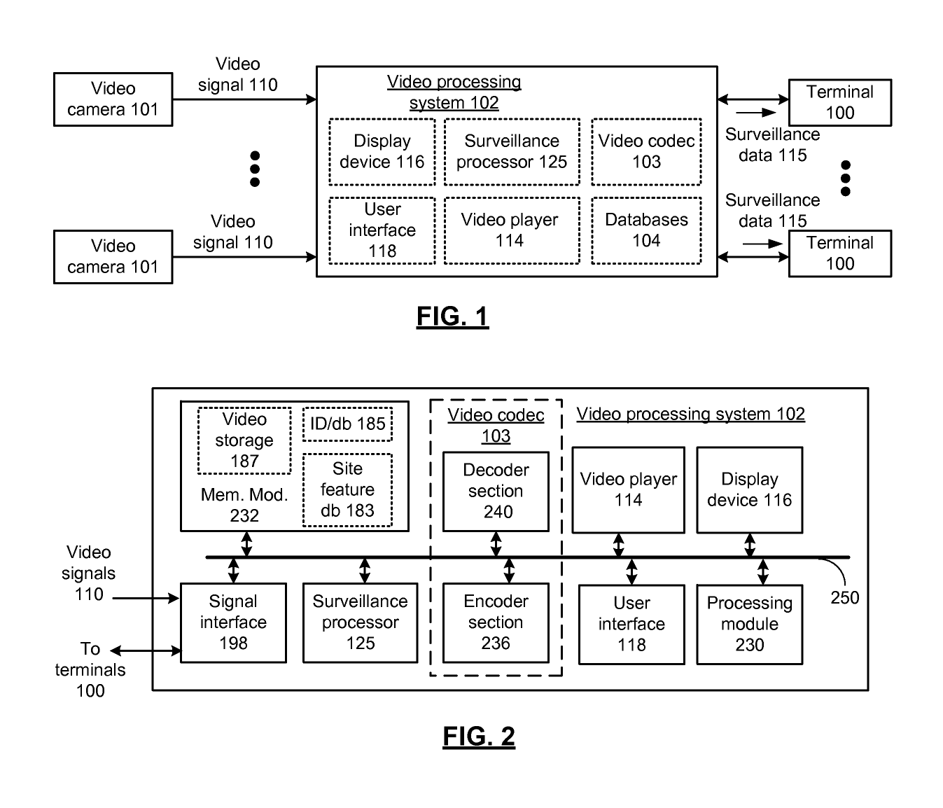

FIG. 1 presents a block diagram representation of a video processing system 102 in accordance with an embodiment of the present disclosure. In particular, a video processing system 102 is presented for use in conjunction with a video surveillance system that includes a plurality of video cameras 101 that produce a corresponding plurality of video signals 110 of one or more surveillance sites. The video cameras 101 can include a lens and digital image sensor such as a charge coupled device (CCD), complementary metal oxide semiconductor (CMOS) device or other video capture device that produces the video signal 110.

In an embodiment of the present disclosure, the video signals 110 can be a digital audio/video signal in an uncompressed digital audio/video format such as high-definition multimedia interface (HDMI) formatted data, International Telecommunications Union recommendation BT.656 formatted data, inter-integrated circuit sound (I2S) formatted data, and/or other digital A/V data formats. The video signal 110 can be a digital video signal in a compressed digital video format such as H.264, H.265, MPEG-4 Part 10 Advanced Video Coding (AVC) or other digital format such as a Moving Picture Experts Group (MPEG) format (such as MPEG1, MPEG2 or MPEG4), Quicktime format, Real Media format, Windows Media Video (WMV) or Audio Video Interleave (AVI), or another digital video format, either standard or proprietary.

While not specifically shown, the video processing system 102 can receive the video signals 110 via a network such as the Internet, a local area network, as either wired or wireless basis. The signal interface 198 of the video processing system 102 includes at least one wired or wireless transceiver or other signal interface that operates to receive the plurality of video signals 110 and further to communicate with a plurality of terminals 100. When carried over a network, the signal interface 198 can optionally unpack the video signals 110 from a transport or container format and/or decrypt the video signals 110.

As shown, the video processing system can include a video player 114, a display device 116, a user interface 118, a video codec 103 and databases 104, such as a site feature database, an identification database, a database of stored video signals or other databases. The video player 114 can operate in response to user commands received via user interface 118 to receive the video signals 110 and to decode or otherwise process the video signals 110 for display on the display device 116.

The video processing system 102 also includes a surveillance processor 125 that is configured to process the video signals 110 and to recognize and track one or more persons in at least one of the video signals 110 and an emotional state corresponding to these person(s) and that generates surveillance data 115 corresponding to these person(s), based on the emotional state corresponding to these person(s). The surveillance data 115 can be received and processed for display on the display device 116 and/or sent to any or all of the terminals 100. For example, the surveillance processor 125 can detect and track the movement of one or more persons throughout different views of a surveillance site corresponding to the video signals 110.

In an embodiment, the surveillance processor 125 determines the emotional state corresponding to persons in the video signals 110 based on facial modelling and recognition that the person has a facial expression corresponding to the emotional state. The emotion state can indicate interest by the person in one or more objects in a site under surveillance, and the surveillance data 115 can indicate the particular object(s). Other emotional states, such as distressed, happy, annoyed or angry, bored, nervous, etc. can likewise be recognized and detected.

In addition to merely recognizing the presence of a person in a video signal 110, the surveillance processor 125 can identify the person based on facial modelling. For example, the surveillance processor 125 can identify a person based on comparison of facial data to an identification database, and generate surveillance data 115 that includes profile data corresponding to the person retrieved from the identification database. Further, the surveillance processor 125 can optionally recognizes a human activity in an image sequence of the video signals 110. The surveillance processor 125 can operate via clustering, syntactic pattern recognition, template analysis or other image, video or audio recognition techniques to search for and identify objects of interest contained in the plurality of shots/scenes or other segments of the video signal 110. Consider an example where the site under surveillance is a store. The surveillance processor 125 can detect a person in a video signal 110 and determine that the person is interested in a particular product or that the person has been unattended for more than a predetermined time and/or has become annoyed. Likewise the surveillance processor 125 can determine that a person appears to be engaged in shoplifting or other illicit activity and generate surveillance data 115 alerting surveillance personnel to such conduct.

In an embodiment, the surveillance processor 125 recognizes a person based on color histogram data and further based on audio data and other image data. For digital video, a color histogram is a representation of the distribution of colors in the frame(s). It represents the number of pixels that have same color or color range. The color histogram can be built for any kind of color space such as Monochrome, RGB, YUV or HSV. Each space has its feature and certain application scope. Like other kinds of histograms, the color histogram is a statistic that can be viewed as an approximation of an underlying continuous distribution of colors values. Thus the color histogram is relatively invariant with camera transformation. The size of color histogram is decided only by the color space configuration, which makes it provide a compact summarization of the video in spite of pixel number. For all the above reasons, color histogram is a good low-level feature for video content analysis.

The surveillance processor 125 can recognize a person or human activity based on individual images in the image sequence delineated by shots, scenes, a group of pictures (GOP) or other time periods corresponding to a particular event or action. In addition to merely recognizing the presence one or more persons in a video image, the surveillance processor 125 can include a database of unique identifiers that correspond to particular persons to be searched for and possibly identified in video signals 110 being analyzed along with corresponding profile data for these persons.

While, in other embodiments, the surveillance processor 125 can be implemented in other ways, in the embodiment shown, the surveillance processor 125 is implemented in a video processing system 102 includes a video codec 103 configured to encode, decode and/or transcode the video signal 110 to form a processed video signal. In an embodiment where the video signals 110 are compressed, the video codec 103 processes the video signals 110 by decoding the video signals for display and/or transcoding the video signals 110 for storage. In an embodiment where the video signals 110 are uncompressed, the video codec 103 can encode the video signals 110 for storage.

Video encoding/decoding and pattern recognition are both computational complex tasks, especially when performed on high resolution videos. Some temporal and spatial information, such as motion vectors and statistical information of blocks and shot segmentation are useful for both tasks. So if the two tasks are developed together, they can share information and economize on the efforts needed to implement these tasks. In an embodiment, the surveillance processor 125 recognizes the persons, their emotional states and/or human activities based on coding feedback data from the video codec 103.

In an embodiment, the video codec 103 generates the coding feedback data in conjunction with the processing of the image sequence. Color histogram data generated by the video codec 103 can be provided as coding feedback data that is used by the surveillance processor 125 in recognizing and tracking faces in an image sequence. In addition to color histogram data, other coding feedback generated by the video codec 103 in the video encoding/decoding or transcoding can be employed to aid the process of recognizing and tracking faces, recognizing emotional states, objects and human activities in the video signals 110. Temporal feedback in the form of motion vectors estimated in encoding or retrieved in decoding (or motion information gotten by optical flow for very low resolution) can be used by surveillance processor 125 for motion-based pattern partition or recognition via a variety of moving group algorithms. In addition, temporal information can be used by surveillance processor 125 to improve recognition by temporal noise filtering, providing multiple picture candidates to be selected from for recognition of the best image in an image sequence, as well as for recognition of temporal features over a sequence of images. Spatial information such as statistical information, like variance, frequency components and bit consumption estimated from input YUV or retrieved for input streams, can be used for texture based pattern partition and recognition by a variety of different classifiers. More recognition features, like structure, texture, color and motion characters can be used for precise pattern partition and recognition.

In addition, feedback from the surveillance processor 125 can be used to guide the encoding or transcoding performed by video codec 103. After pattern recognition, more specific structural and statistically information can be retrieved that can guide mode decision and rate control to improve quality and performance in encoding or transcoding of the video signal 110. Pattern recognition can also generate feedback that identifies regions with different characteristics. These more contextually correct and grouped motion vectors can improve quality and save bits for encoding, especially in low bit rate cases. After pattern recognition, estimated motion vectors can be grouped and processed in accordance with the feedback. In particular, pattern recognition feedback can be used by video codec 103 for bit allocation in different regions of an image or image sequence in encoding or transcoding of the video signal 110. With pattern recognition and the codec running together, they can provide powerful aids to each other.

Further examples of the video processing system 102 including several optional functions and features are presented in conjunctions with FIGS. 2-11 that follow.

FIG. 2 presents a block diagram representation of a video processing system 102 in accordance with an embodiment of the present disclosure. In particular, video processing system 102 includes a video codec 103 having decoder section 240 and encoder section 236 that operates in accordance with many of the functions and features of the H.264 standard, H.265 standard, the MPEG-4 standard, VC-1 (SMPTE standard 421M) or other standard, to decode, encode, transrate or transcode video signals, such as video signals 110 described in conjunction with FIG. 1, to generate a processed video signal for storage and/or display.

In conjunction with the encoding, decoding and/or transcoding of the video signal received via receiving module 100 or from video camera 101, the video codec 103 generates or retrieves the decoded image sequence of the content of video signal along with coding feedback for transfer to the surveillance processor 125. The surveillance processor 125 operates based on the image sequence to generate surveillance data 115 and optionally pattern recognition feedback for transfer back to the video codec 103. In particular, surveillance processor 125 can operate via clustering, statistical pattern recognition, syntactic pattern recognition or via other pattern detection algorithms or methodologies to detect or recognize a pattern in an image or image sequence (frame or field) of video signals 110, corresponding to an object of interest such as a person and their emotional state, a human activity and/or other objects and generates pattern recognition data and surveillance data 115 in response thereto. The signal interface 198 can include one or more parallel or serial wired interfaces, wireless interfaces or other input/output interfaces.

The processing module 230 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 232. Memory module 232 includes one or more storage devices to store an identification (ID) database (db) 185, a site feature database 183, as well as providing video storage for processed video signals generated based on video signals 110 and/or corresponding surveillance data 115. Memory module 232 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 230 and memory module 232 are coupled, via bus 250, to the signal interface 198 and a plurality of other modules, such as surveillance processor 125, video player 114, display device 116, user interface 118, decoder section 240 and encoder section 236. In an embodiment of the present disclosure, the signal interface 198, video codec 103, video player 114, display device 116, user interface 118, and surveillance processor 125 each operate in conjunction with the processing module 230 and memory module 232. The modules of video processing system 102 can each be implemented in software, firmware or hardware, depending on the particular implementation of processing module 230. It should also be noted that the software implementations of the present disclosure can be stored on a tangible storage medium such as a magnetic or optical disk, read-only memory or random access memory and also be produced as an article of manufacture. While a particular bus architecture is shown, alternative architectures using direct connectivity between one or more modules and/or additional busses can likewise be implemented in accordance with the present disclosure.

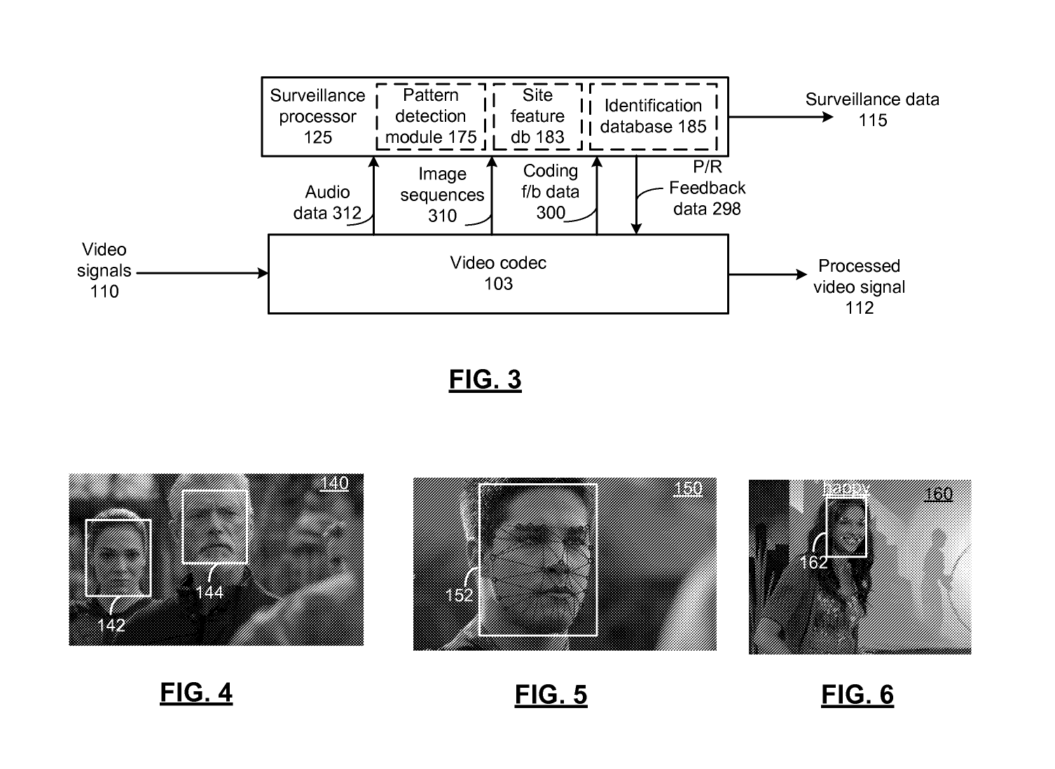

FIG. 3 presents a block diagram representation of a video codec 103 and surveillance processor 125 in accordance with an embodiment of the present disclosure. As previously discussed, the video codec 103 generates a processed video signal 112 for storage and/or display based on the video signals 110, retrieves or generates an image sequence 310 and further generates coding feedback data 300. The coding feedback data 300 can include temporal or spatial encoding information, and/or color histogram data corresponding to a plurality of images in the image sequences 310.

A pattern detection module 175 analyzes an image sequence 310 to search for objects of interest in the images of the image sequence based optionally on audio data 312, and coding feedback data 300. The pattern detection module 175 generates pattern recognition data that identifies objects of interest when present in one of the plurality of images along with the specific location of the object(s) of interest by image and by location within the image.

In an embodiment, the pattern detection module 175 tracks a candidate facial region over the plurality of images and detects a facial region based on an identification of facial features in the candidate facial region over the plurality of images. The facial features can include the identification, position and movement of various facial features including eyes; eyebrows, nose, cheek, jaw, mouth etc. In particular, face candidates can be validated for face detection based on the further recognition by pattern detection module 175 of facial features, like eye blinking (both eyes blink together, which discriminates face motion from others; the eyes are symmetrically positioned with a fixed separation, which provides a means to normalize the size and orientation of the head.), shape, size, motion and relative position of face, eyebrows, eyes, nose, mouth, cheekbones and jaw. Any of these facial features can be used extracted from the image sequences 310 and used by pattern detection module 175 to eliminate false detections and further used by pattern detection module to determine an emotional state of a person. Further, the pattern detection module 175 can employ temporal recognition to extract three-dimensional features based on different facial perspectives included in the plurality of images to improve the accuracy of the recognition of the face and identification of the person. Using temporal information, the problems of face detection including poor lighting, partially covering, size and posture sensitivity can be partly solved based on such facial tracking. Furthermore, based on profile view from a range of viewing angles, more accurate and 3D features such as contour of eye sockets, nose and chin can be extracted.

In this mode of operation, the pattern detection module 175 generates pattern recognition data that can include an indication that human was detected, a location of the region of the human and pattern recognition data that includes, for example human action descriptors and correlates the human action to a corresponding video shot. The pattern detection module 175 can subdivide the process of human action recognition into: moving object detecting, human discriminating, tracking, action understanding and recognition. In particular, the pattern detection module 175 can identify a plurality of moving objects in the plurality of images. For example, motion objects can be partitioned from background. The pattern detection module 175 can then discriminate one or more humans from the plurality of moving objects. Human motion can be non-rigid and periodic. Shape-based features, including color and shape of face and head, width-height-ratio, limb positions and areas, tile angle of human body, distance between feet, projection and contour character, etc. can be employed to aid in this discrimination. These shape, color and/or motion features can be recognized as corresponding to human action via a classifier such as neural network. The action of the human can be tracked over the images in a sequence and a particular type of human action can be recognized in the plurality of images. Individuals, presented as a group of corners and edges etc., can be precisely tracked using algorithms such as model-based and active contour-based algorithm. Gross moving information can be achieved via a Kalman filter or other filter techniques. Based on the tracking information, action recognition can be implemented by Hidden Markov Model, dynamic Bayesian networks, syntactic approaches or via other pattern recognition algorithm.

In an embodiment, the pattern detection module 175 operates based on a classifier function that maps an input attribute vector, x=(x1, x2, x3, x4, . . . , xn), to a confidence that the input belongs to a class, that is, f(x)=confidence(class). The input attribute data can include a color histogram data, audio data, image statistics, motion vector data, other coding feedback data 300 and other attributes extracted from the image sequences 310. Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. This makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module.

It should be noted that classifier functions containing multiple different kinds of attribute data can provide a powerful approach to recognition. In one mode of operation, the pattern detection module 175 can recognize content that includes an object, based on color histogram data corresponding to colors of the object and sound data corresponding to a sound of the object and optionally other features. For example, a perfume bottle can be recognized based on a distinctive color histogram, a shape corresponding to the bottle, the sound of the perfumed being sprayed, and further based on text recognition of the bottle's box or label.

In another mode of operation, the pattern detection module 175 can recognize content that includes a person, based on color histogram data corresponding to colors of the person's face and sound data corresponding to a voice of the person. For example, color histogram data can be used to identify a region that contains a face, facial and speaker recognition can be used together to identify a person of interest from the identification database 185. Surveillance data 115 can indicate a presence of persons and their emotional states, the identification of these persons along with profile data corresponding to these persons retrieved from the identification database 185, human activities associated with these persons, the location of these persons in associate with site features extracted from a site feature database 183, one or more alerts indicating suggested attention or action by surveillance personnel, and/or other surveillance data.

In addition to searching for objects of interest, pattern recognition feedback 298 in the form of pattern recognition data or other feedback from the surveillance processor 125 can be used to guide the encoding or transcoding performed by video codec 103. After pattern recognition, more specific structural and statistically information can be generated as pattern recognition feedback 298 that can, for instance, guide mode decision and rate control to improve quality and performance in encoding or transcoding of the video signal 110. Surveillance processor 125 can also generate pattern recognition feedback 298 that identifies regions with different characteristics. These more contextually correct and grouped motion vectors can improve quality and save bits for encoding, especially in low bit rate cases. After pattern recognition, estimated motion vectors can be grouped and processed in accordance with the pattern recognition feedback 298.

Pattern recognition feedback 298 can be used by video codec 103 for bit allocation in different regions of an image or image sequence in encoding or transcoding of the video signal 110 into processed video 112 display or for storage. In particular, facial regions and other objects of interest can be encoded with greater resolution or accuracy to aid in video surveillance or forensics. For example, when pattern recognition data from the pattern detection module 175 can indicate a face has been detected and the location of the facial region can also be used as pattern recognition feedback 298. The pattern recognition data can include facial characteristic data such as position in stream, shape, size and relative position of face, eyebrows, eyes, nose, mouth, cheekbones and jaw, skin texture and visual details of the skin (lines, patterns, and spots apparent in a person's skin), or even enhanced, normalized and compressed face images. In response, the encoder section 236 can guide the encoding of the image sequence based on the location of the facial region. In addition, pattern recognition feedback 298 that includes facial information can be used to guide mode selection and bit allocation during encoding. Further, the pattern recognition data and pattern recognition feedback 298 can further indicate the location of eyes or mouth in the facial region for use by the encoder section 236 to allocate greater resolution to these important facial features. For example, in very low bit rate cases the encoder section 236 can avoid the use of inter-mode coding in the region around blinking eyes and/or a talking mouth, allocating more encoding bits should to these face areas.

FIG. 4 presents a pictorial diagram representation of an image in accordance with a further embodiment of the present disclosure. In particular, an image 140 is shown as processed by surveillance processor 125. As previously discussed, the surveillance processor 125 is configured to process the video signals 110 and to recognize and track one or more persons in at least one of the video signals 110. In the example shown, the facial regions of persons 142 and 144 are being tracked and the processed video signal optionally includes framing of these facial regions to aid the surveillance personnel in tracking these persons.

FIG. 5 presents a pictorial diagram representation of an image in accordance with a further embodiment of the present disclosure. In particular, an image 150 is shown as processed by surveillance processor 125. As previously discussed, the surveillance processor 125 is configured to process the video signals 110 and to recognize and track one or more persons in at least one of the video signals 110 and an emotional state corresponding to these person(s) and that generates surveillance data corresponding to these person(s), based on the emotional state corresponding to these person(s).

In the example show, the image 150 includes a facial region 152. The surveillance processor 125 uses a 3D human face model that looks like a mesh to track the facial features of the person in order to determine an emotion state based on the motion and relative position of face, eyebrows, eyes, nose, mouth, cheekbones and jaw. In this fashion, the surveillance processor 125 can determine emotion states, such as happiness, boredom, sadness, annoyance or anger, distress, impatience, nervousness and further a level of interest in an object or activity.

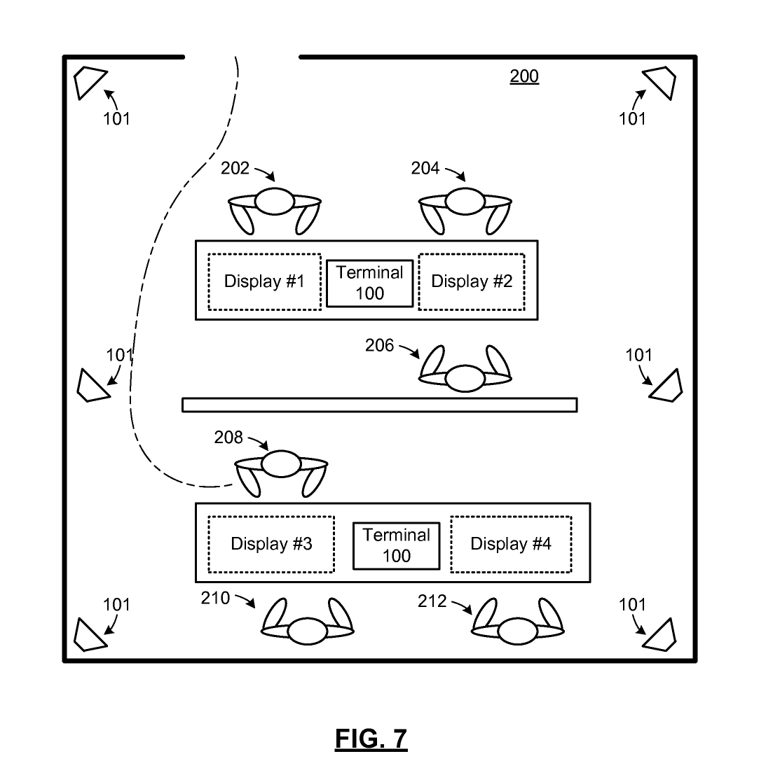

FIG. 6 presents a pictorial diagram representation of an image in accordance with a further embodiment of the present disclosure. In particular, an image 160 is shown as processed by surveillance processor 125. As previously discussed, the surveillance processor 125 is configured to process the video signals 110 and to recognize and track one or more persons in at least one of the video signals 110 and an emotional state corresponding to these person(s) and that generates surveillance data corresponding to these person(s), based on the emotional state corresponding to these person(s). In the example shown, the analysis of the facial features in facial region 162 indicates that the person is happy. This emotion state can be indicated in surveillances data 115 generated by the surveillance processor 125 and optionally displayed to surveillance personal via display device 116.

FIG. 7 presents a block diagram representation of a surveillance site in accordance with a further embodiment of the present disclosure. In particular, a surveillance site is shown, such as a store having display areas 1-5 that is configured with multiple video cameras 101 coupled to a video processing system, such as video processing system 102 with surveillance processor 125. Store service personnel are represented as 206, 210 and 212. Customers are represented by 202, 204 and 208.

In the example shown, the surveillance processor 125 processes the video signals from the video cameras 101 to recognize and track the persons 202, 204 and 208 and to determine their emotional state. As discussed, the surveillance processor 125 can detect and track the movement these persons throughout different views of a surveillance site 200 corresponding to the video signals. In this fashion, surveillance personnel can tract the movement of person 208 as he/she enters the store and arrives at his/her current location.

As discussed, the surveillance processor 125 determines the emotional state corresponding to persons in the video signals 110 based on facial modelling and recognition that the person has a facial expression corresponding to the emotional state. In the example shown, person 204 is happy and engaged in a discussion of items in display #2 with service person 206. Person 208 is determined to be quite nervous and engaged in suspicious activity in the store. In addition, person 208 has been recognized as a particular person and information pertaining to this person's criminal record and other profile data has been retrieved from an identification database and included in the surveillance data 115 along with an appropriate alert. Surveillance personnel have alerted the service person 210 via adjacent terminal 100 to monitor the activities of person 208 more closely.

The surveillance processor 125 has recognized person 202 as a frequent shopper, determines that this person has shown interested in the items in display#1, but is now becoming annoyed. Information retrieved from a site feature database 183 indicates that display #1 contains Burberry scarves that were the object of person 202's interest. Surveillance data 115 is generated to the adjacent terminal 100 to alert service person 212 to help person 202 and to let them know that person 202 is interested in Burberry products.

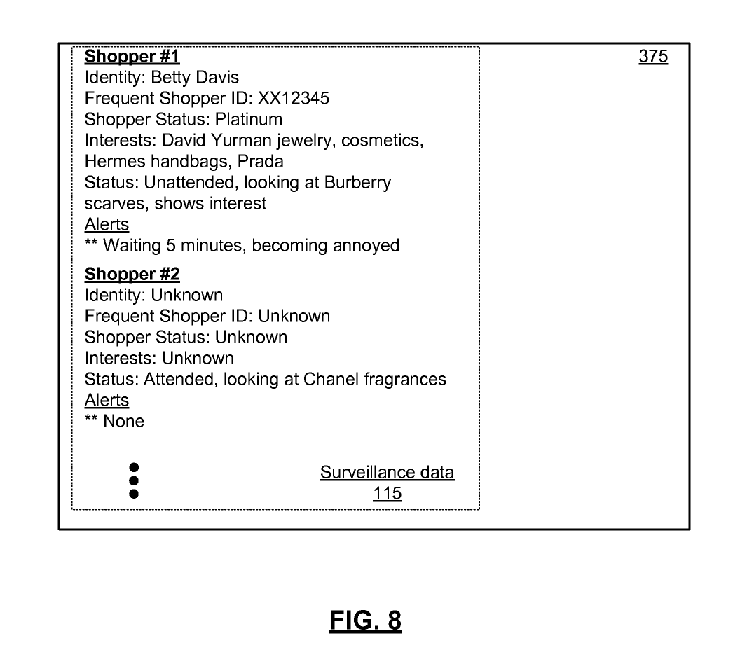

FIG. 8 presents pictorial diagram representation of a screen display in accordance with a further embodiment of the present disclosure. In particular, a screen display 375 is shown for a display device associated with a video processing system 102 and/or terminal 100. Surveillance data 115, generated by surveillance processor 125 in conjunction with identification database 185 and site feature database 183, is presented that follows along with the example presented in conjunction with FIG. 7. In this case, surveillance data 115 pertaining to shopper#1 (person 202) and shopper#2 (person 204) is presented. While surveillance data 115 presented in isolation, it should be noted that this surveillance data can be superimposed on or juxtaposed with the display of the corresponding processed video signals 112 for the store when displayed on a display device such as display device 116.

In the example shown, Shopper#1 has been identified from the identification database 185 as “Betty Davis”. The shopper's profile data is retrieved from the identification database and used to generate surveillance data 115 that indicates a frequent shopper ID, a Platinum tier shopper status, and a variety of interests based on past purchases, interaction with the store's website and/or past visits to the store. The surveillance data 115 further indicates while Betty has shown interest in Burberry scarves, she has been unattended for more than 5 minutes and is becoming annoyed. In an embodiment, the video processing system shares the surveillance data 115 with the terminal 100 (such as a checkout terminal) to let the service person know that Betty is an important customer, and further to automatically identify Betty at the time of sale to terminal 100 so that she need not be asked for identification if she pays by credit card. Further, if Betty produces a card with a name that is not her own, the terminal 100 can suspend the transaction while the service person asks for additional facts.

In the example shown, Shopper#2 has not been identified from the identification database 185. In this case, the surveillance processor 125 begins to collect and store profile data for this person in the identification database 185 that can be refined if the person makes a purchase with a credit card or is otherwise identified by the system based on data received from a checkout terminal, such as terminal 100.

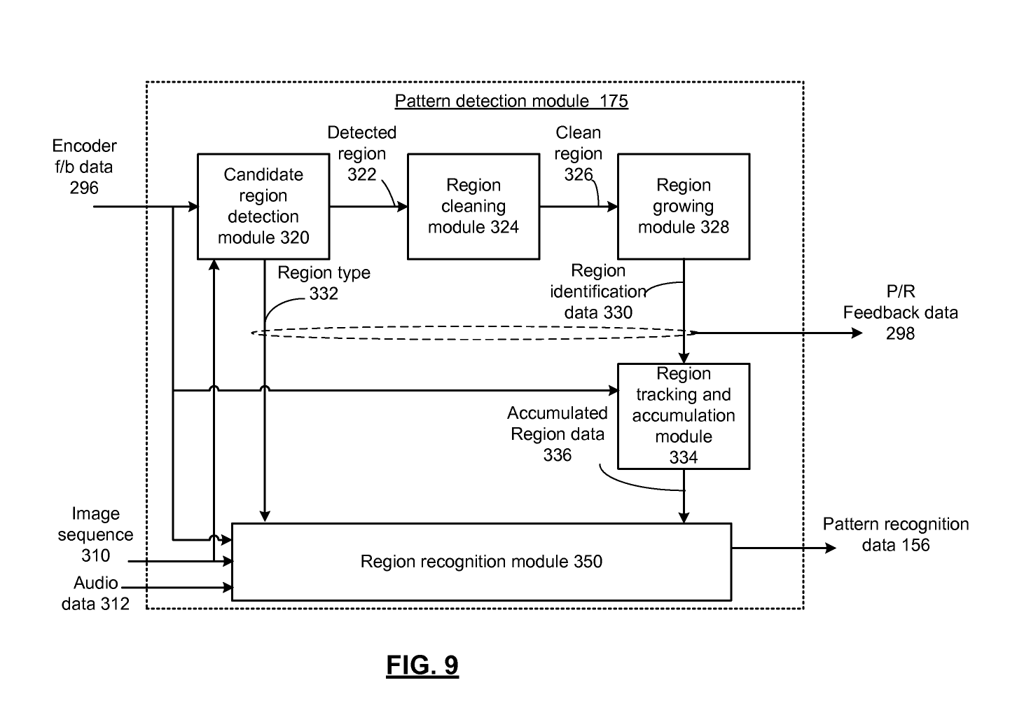

FIG. 9 presents a block diagram representation of a pattern detection module 175 in accordance with a further embodiment of the present disclosure. In particular, pattern detection module 175 includes a candidate region detection module 320 for detecting a detected region 322 in at least one image of image sequence 310. In operation, the candidate region detection module 320 can detect the presence of a particular pattern or other region of interest to be recognized as a particular region type. An example of such a pattern is a human face or other face, human action, or other object or feature. Pattern detection module 175 optionally includes a region cleaning module 324 that generates a clean region 326 based on the detected region 322, such via a morphological operation. Pattern detection module 175 further includes a region growing module 328 that expands the clean region 326 to generate a region identification data 330 that identifies the region containing the pattern of interest. The identified region type 332 and the region identification data can be output as pattern recognition feedback data 298.

Considering, for example, the case where the image sequence 310 includes a human face and the pattern detection module 175 generates a region corresponding the human face, candidate region detection module 320 can generate detected region 322 based on the detection of pixel color values corresponding to facial features such as skin tones. Region cleaning module can generate a more contiguous region that contains these facial features and region growing module can grow this region to include the surrounding hair and other image portions to ensure that the entire face is included in the region identified by region identification data 330.

The candidate region detection module 320 further operates based on motion vector data to track the position of candidate region through the images in the image sequence 310. Motion vectors and other encoder feedback data 296 are also made available to region tracking and accumulation module 334 and region recognition module 350. The region tracking and accumulation module 334 provides accumulated region data 336 that includes a temporal accumulation of the candidate regions of interest to enable temporal recognition via region recognition module 350. In this fashion, region recognition module 350 can generate pattern recognition data 156 based on such features as facial motion, human actions, three-dimensional modeling and other features recognized and extracted based on such temporal recognition.

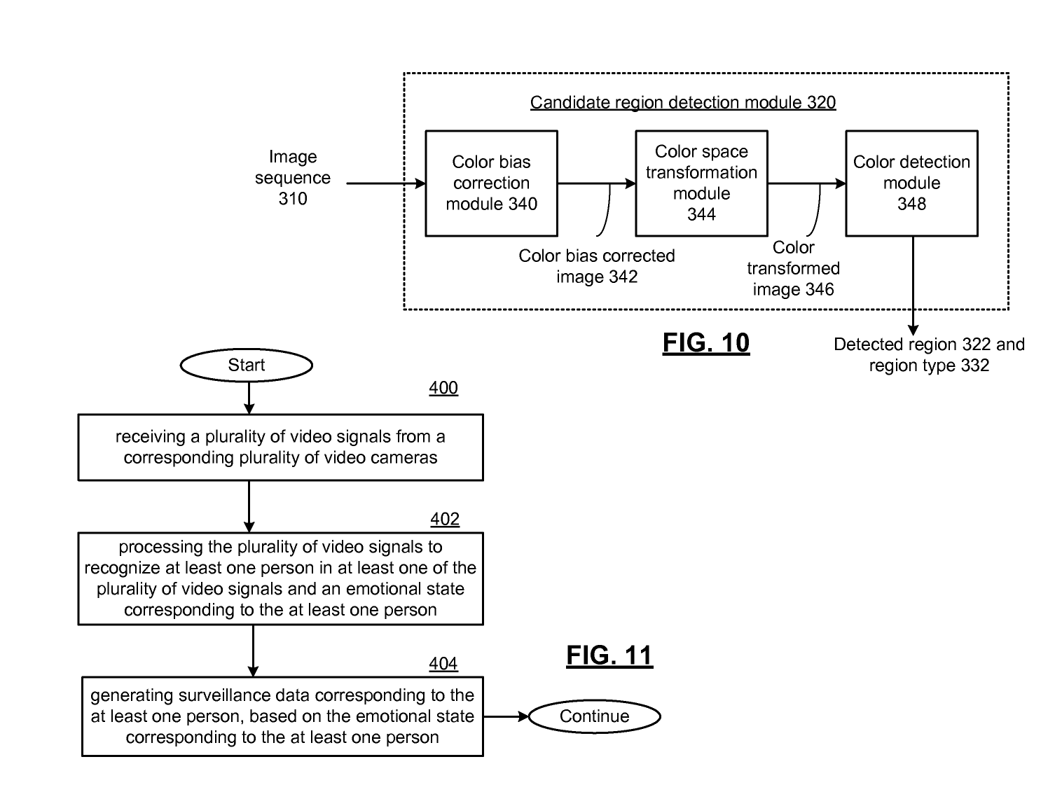

FIG. 10 presents a block diagram representation of a candidate region detection module 320 in accordance with a further embodiment of the present disclosure. In this embodiment, region detection module 320 operates via detection of colors in image sequence 310. Color bias correction module 340 generates a color bias corrected image 342 from image sequence 310. Color space transformation module 344 generates a color transformed image 346 from the color bias corrected image 342. Color detection module generates the detected region 322 from the colors of the color transformed image 346.

For instance, following with the examples previously discussed where human faces are detected, color detection module 348 can operate to detect colors in the color transformed image 346 that correspond to skin tones using an elliptic skin model in the transformed space such as a C_{b}Cᵣ subspace of a transformed YC_{b}Cᵣ space. In particular, a parametric ellipse corresponding to contours of constant Mahalanobis distance can be constructed under the assumption of Gaussian skin tone distribution to identify a detected region 322 based on a two-dimension projection in the C_{b}Cᵣ subspace. As exemplars, the 853,571 pixels corresponding to skin patches from the Heinrich-Hertz-Institute image database can be used for this purpose, however, other exemplars can likewise be used in broader scope of the present disclosure.

FIG. 11 presents a flowchart representation of a method in accordance with an embodiment of the present disclosure. In particular a method is presented for use in conjunction with one more functions and features described in conjunction with FIGS. 1-10. Step 400 includes receiving a plurality of video signals from a corresponding plurality of video cameras. Step 402 includes processing the plurality of video signals to recognize person(s) in at least one of the plurality of video signals and an emotional state corresponding to the person(s). Step 404 includes generating surveillance data corresponding to the person(s), based on the emotional state corresponding to the person(s).

In an embodiment, determining the emotional state corresponding to the person(s) is step 402 is based on facial modelling and recognition that person(s) has a facial expression corresponding to the emotional state. The emotion state can indicate interest by the person(s) in an object in a site under surveillance, and wherein the surveillance data indicates the object. In a particular example, the site under surveillance comprises a store, and the object comprises a product of interest to the person(s) and the surveillance data further indicates that the person(s) of interest has been unattended for more than a predetermined time.

The method can further include identifying the person(s) based on facial modelling and further based on comparison of facial data to an identification database. The surveillance data can include profile data corresponding to the person(s) retrieved from the identification database. The method can further include recognizing a human activity associated with the person(s) and/or tracking movement of the person(s) throughout different views of a surveillance site corresponding to the plurality of video signals.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A video processing system comprising:
a signal interface configured to receive a plurality of video signals from a corresponding plurality of video cameras; and
a surveillance processor configured to process the plurality of video signals and to recognize at least one person in at least one of the plurality of video signals and an emotional state corresponding to the at least one person and that generates surveillance data corresponding to the at least one person, based on the emotional state corresponding to the at least one person.

2. The system of claim 1 wherein the surveillance processor determines the emotional state corresponding to the at least one person based on facial modelling and recognition that the at least one person has a facial expression corresponding to the emotional state.

3. The system of claim 2 wherein the emotion state indicates interest by the at least one person in an object in a site under surveillance, and wherein the surveillance data indicates the object.

4. The system of claim 3 wherein the site under surveillance comprises a store, and wherein the object comprises a product of interest to the at least one person.

5. The system of claim 4 wherein the surveillance data further indicates that the at least one person of interest has been unattended for more than a predetermined time.

6. The system of claim 1 wherein the surveillance processor identifies the at least one person based on facial modelling.

7. The system of claim 6 wherein the surveillance processor identifies the at least one person further based on comparison of facial data to an identification database, and wherein the surveillance data includes profile data corresponding to the at least one person retrieved from the identification database.

8. The system of claim 1 wherein the surveillance processor further recognizes a human activity associated with the at least one person.

9. The system of claim 1 wherein the surveillance processor tracks movement of the at least one person throughout different views of a surveillance site corresponding to the plurality of video signals.

10. A method comprising:
receiving a plurality of video signals from a corresponding plurality of video cameras;
processing the plurality of video signals to recognize at least one person in at least one of the plurality of video signals and an emotional state corresponding to the at least one person; and
generating surveillance data corresponding to the at least one person, based on the emotional state corresponding to the at least one person.

11. The method of claim 10 wherein determining the emotional state corresponding to the at least one person is based on facial modelling and recognition that the at least one person has a facial expression corresponding to the emotional state.

12. The method of claim 11 wherein the emotion state indicates interest by the at least one person in an object in a site under surveillance, and wherein the surveillance data indicates the object.

13. The method of claim 12 wherein the site under surveillance comprises a store, and wherein the object comprises a product of interest to the at least one person and wherein the surveillance data further indicates that the at least one person of interest has been unattended for more than a predetermined time.

14. The method of claim 10 further comprising:
identifying the at least one person based on facial modelling and further based on comparison of facial data to an identification database; and
wherein the surveillance data includes profile data corresponding to the at least one person retrieved from the identification database.

15. The method of claim 10 further comprising:
recognizing a human activity associated with the at least one person.

16. The method of claim 10 further comprising:
tracking movement of the at least one person throughout different views of a surveillance site corresponding to the plurality of video signals.
